(19) United States
(12) Patent Application Publication
(10) Pub. No.: US 2008/0073986 A1
(43) Pub. Date: Mar. 27, 2008

(54) Permanent magnet rotor type motor and method for manufacturing the same

(75) Inventor: Seon Joong Lee, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/645,698

(22) Filed: Dec. 27, 2006

(30) Foreign Application Priority Data
Sep. 26, 2006 (KR) 10-2006-0093466
Sep. 26, 2006 (KR) 10-2006-0093467
Sep. 27, 2006 (KR) 10-2006-0093973

(51) Int. Cl. H02K 9/00; H02K 3/24; H02K 11/00; H02K 5/00

(52) U.S. Cl. 310/71; 310/64; 310/68 R; 310/89; 310/58

(57) ABSTRACT

Disclosed is a permanent type motor in which a permanent magnet is attached to or embedded in a rotor in a rotatable manner. More particularly, a permanent magnet rotor type motor, which can be easily manufactured while achieving an improvement in heat-emission performance, is disclosed. The permanent magnet rotor type motor includes a stator having a stator coil would about an insulator, a printed circuit board (PCB) secured to an upper portion of the stator and having a powered device mounted on the PCB, and a bracket having a heat-emitting portion formed at an upper surface of the bracket, the bracket being configured to receive the stator and the PCB such that the powered device comes into contact with the heat-emitting portion.

This application claims the benefit of the Korean Patent Application No. 10-2006-0093466 filed on Sep. 26, 2006, No. 10-2006-0093467 filed on Sep. 26, 2006 and No. 10-2006-0093973 filed on Sep. 27, 2006 which are hereby incorporated by reference as if fully set forth herein.

### BACKGROUND OF THE INVENTION

1. Field of the Invention

The present invention relates to a permanent magnet rotor type motor in which a permanent magnet is attached to or embedded in a rotor in a rotatable manner. More particularly, the present invention relates to a permanent magnet rotor type motor which can be easily manufactured while achieving an improvement in heat-emission performance.

2. Discussion of the Related Art

A representative example of permanent magnet rotor type motors is a brushless DC (BLDC) motor. The BLDC motor is an adjustable speed motor capable of easily controlling a rotating speed and rotating direction, and is mainly used as drive devices of home electronics, etc.

In addition to the BLDC motor, there is a switched reluctance motor as another representative example of permanent magnet rotor type motors. First, in the case of the BLDC motor, a permanent magnet rotor is rotated as the direction of a magnetic field is changed by electronically changing the flow direction of electric current. On the other hand, in the case of the switched reluctance motor, a permanent magnet rotor is rotated in response to the reluctance variation of a magnetic field. Here, the reluctance variation is caused by controlling conductive current flowing through a permanent magnet of the rotor and a coil of each phase installed to a stator in a state wherein an AC voltage of each phase is applied to the stator.

Now, a conventional BLDC motor will be described with reference to FIGS. 1 and 2.

FIG. 1 is a perspective view illustrating a stator provided in a BLDC motor, and FIG. 2 is a perspective view illustrating a printed circuit board (PCB) secured to the stator.

As shown in FIGS. 1 and 2, a stator 50 provided in the conventional BLDC motor includes a stator core 51, upper and lower insulator portions 52 and 53 that are inserted into the stator core 51 from upper and lower sides of the stator core 51, respectively, and stator coils 58 of different phases u, v, and w that are wound on the upper and lower insulator portions 52 and 53. Terminals 54, 55, and 56 of the stator coils 58 of the different phases u, v, and w are connected to a printed circuit board (PCB) 60 and secured to the PCB 60 by a soldering process.

Although not shown in FIGS. 1 and 2, the PCB 60 is secured to the stator 50, more particularly, to the upper insulator portion 52, by use of separate coupling means.

A permanent magnet rotor (not shown) is located in the stator 50 such that the rotor is connected to a rotating shaft (not shown). Thereafter, the stator 50 and the rotor are received in a bracket (not shown). Meanwhile, the rotating shaft and the rotor are rotatably supported by a bearing (not shown) that is secured to the bracket.

Now, a method for controlling the BLDC motor will be described with reference to FIG. 3.

As shown in FIG. 3, for the control of the BLDC motor 5, there are provided a rectifier 11, a condenser 12, an inverter 13, a rotor position detecting circuit 15, a microcomputer 16, and an inverter driver 17. Here, the microcomputer 16 is used to control home electronics, etc. in which the BLDC motor 5 is installed. Generally, all the other constituent elements except for the microcomputer 16 are mounted on the PCB 60 of the BLDC motor 5.

The rectifier 11 generally serves to convert an AC voltage, supplied from a single phase AC power source 18, into a DC voltage. The condenser 12 serves as a smoothing condenser to smooth the rectified voltage.

The inverter 13 converts the smoothed DC voltage from the condenser 12 into a predetermined AC voltage depending on each phase, to thereby output the predetermined AC voltage of each phase. The motor 5 is operated on the basis of the voltage inputted through the inverter 13.

Meanwhile, to operate the BLDC motor, the position of the rotor must coincide with the phase of the supplied voltage. Accordingly, there generally exists a necessity for the rotor position detecting circuit 15 capable of detecting the position of the rotor. The rotor position detecting circuit 15 generally includes a position detecting sensor. Recently, a hall sensor (not shown) is mainly used as the position detecting sensor.

Here, the hall sensor is generally adapted to detect the position of the rotor on the basis of rotation of a permanent magnet, which is provided on an imaginary extension line of a motor rotating shaft and used to detect a position of the motor during rotation of the motor.

Recently, there has been also provided a rotor position detector instead of separately preparing the position detecting permanent magnet. The rotor position detector is adapted to detect the position of the rotor on the basis of rotation of a permanent magnet provided at the rotor.

The microcomputer 16 serves to compare the position of the rotor, which was detected via the rotor position detecting circuit 15, with a preset speed, so as to output a signal for controlling the speed of the motor on the basis of the comparative result.

The inverter driver 17 serves to generate an inverter drive signal on the basis of the control signal outputted from the microcomputer 16, to allow the voltage of each phase outputted from the inverter 13 to be applied to the motor 5 after being converted in a pulse width modulation (PWM) manner. Thereby, various operating conditions of the motor, such as a rotating speed, torque, and rotating direction of the motor can be controlled.

Now, the operation of the BLDC having the above described configuration will be described.

First, if the single phase AC power 18 (that generally supplies current of 220V and 60 Hz) inputs an AC voltage required for the operation of the motor 5 to the rectifier 11, the rectifier 11 acts to rectify the inputted AC voltage, to thereby output a DC voltage.

Then, the rectified DC voltage from the rectifier 11 is converted into a predetermined value voltage (generally, of 310V) by the condenser 12. The inverter 13 again coverts the DC voltage into a predetermined AC voltage of each phase on the basis of the signal from the inverter driver 17, to thereby output the AC voltage of each phase.

Here, the predetermined AC voltage converted by the inverter 13 acts to apply current to the stator coils of the stator having different phases u, v, and w. Thereby, a rotational magnetic field is generated as the permanent magnet of the rotor interacts with a magnetic field generated by the current flowing through the stator coils. As a result, the rotor can be rotated by being synchronized with the rotational magnetic field.

Meanwhile, the rotor position detecting circuit 15 detects the position of the rotor on the basis of the predetermined AC voltage of each phase, and outputs the resulting signal.

The microcomputer 16 compares the position of the rotor, which was detected by the rotor position detecting circuit 15, with a preset speed of the rotor, and outputs a signal for controlling the motor on the basis of the comparative result.

Here, the motor control signal outputted from the microcomputer 16 is converted into a signal for driving powered devices, such as certain switch devices (Q1 to Q6) of the inverter 13, by the inverter driver 17. Specifically, as the switch devices Q1 to Q6 are turned on and off, the magnitude of the AC voltage to be applied to the motor can be controlled in a PWM manner. As a result, the magnitude of current to be applied to the motor can be controlled, resulting in efficient control in the operation of the motor. The PWM manner is well known to those skilled in the art and a detailed description thereof will be omitted herein.

Here, the PWM manner for the operation of the motor results from a method for driving the powered devices. When the powered devices are controlled by a standard value of an analogue waveform (here, standard voltage), the powered devices are adapted to operate in their active region. This may result in a great amount of loss and heat emission in the powered devices.

Accordingly, the PWM manner is adopted to control a voltage or current to be applied to the powered devices within a saturation region and an OFF region of the powered devices, so as to minimize the loss and heat emission of the powered devices.

However, when controlling the operation of the motor based on the above described PWM manner, there still exists loss by the inverter. The largest part of the loss is a switching loss that is caused as the switch devices, i.e. powered devices of the inverter are periodically switched.

Now, the switching loss will be described in detail with reference to FIG. 4.

First, if the powered devices are switched on to allow current I to flow therethrough, the flow of the current I is partially limited by the internal resistance of the powered devices as well as the overall load resistance. In this case, the powered devices are affected by only a loss voltage caused by the internal resistance of the powered devices, and the applied overall voltage is determined based on the overall load resistance.

On the other hand, if the powered devices are switched off, the overall voltage is applied to the powered devices and no current flows through the powered devices. In summary, as the powered devices are switched on and off, any one of the voltage or current has a zero value and no power loss occurs.

However, as shown in FIG. 4, during a transition time period of switching on and off the powered devices, the powered devices are affected by both the voltage and the current. This results in power loss, and most of the power loss is represented as heat.

Of course, although not shown in FIG. 4, the above described loss may occur at time points where the powered devices are turned on and off. The switching loss, consequently, causes not only deterioration in the efficiency of the inverter, but also an increase in the temperature of the inverter due to the emission of heat and the resulting power loss. This results in a problem in that the operation range of the motor is limited.

To solve the above described problem, a high capacity inverter or separate heat emission means must be used. This inevitably causes an increase in the size of the motor or home electronics, etc. in which the motor is mounted. Furthermore, the use of the heat emission means complicates the manufacture of the motor.

Accordingly, there has been suggested a strong desire for permanent magnet rotor type motors that can be easily manufactured with low costs while efficiently emitting heat generated from an inverter, more particularly, heat generated from powered devices, such as switching devices.

### SUMMARY OF THE INVENTION

Accordingly, the present invention is directed to a permanent magnet rotor type motor and a method for manufacturing the same that substantially obviate one or more problems due to limitations and disadvantages of the related art.

An object of the present invention is to provide a permanent magnet rotor type motor capable of efficiently emitting heat generated from a printed circuit board (PCB), more particularly, generated from powered devices mounted on the PCB, without having separate heat-emission means.

Another object of the present invention is to provide a permanent magnet rotor type motor which can be easily manufactured with a simplified manufacturing method.

A further object of the present invention is to provide a permanent magnet rotor type motor in which a PCB is stably mounted in a bracket to achieve not only a strong fixation of the PCB, but also an electric connection with an associated element.

Yet another object of the present invention is to provide a permanent magnet rotor type motor capable of guaranteeing easy wiring between a PCB and a stator coil while efficiently preventing wiring errors, and capable of achieving an improvement in the reliability of an electric connection of the PCB and the stator coil.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a permanent magnet rotor type motor comprising: a stator having a stator coil wound about an insulator; a Printed Circuit Board (PCB) secured to an upper portion of the stator and having a powered device mounted on the PCB; and a bracket having a heat-emitting portion formed at an upper surface of the bracket, the bracket being configured to receive the stator and the PCB such that the powered device comes into contact with the heat-emitting portion.

Here, the stator coil may be wound on the stator via the insulator, and the insulator may comprise an upper insulator portion and a lower insulator portion coupled to upper and lower portions of the stator.

The bracket may comprise an upper bracket portion formed with the heat-emitting portion and a lower bracket portion coupled to the upper bracket portion. As the upper bracket portion and the lower bracket portion are coupled to each other, they define an outer appearance of the motor and are able to receive the stator and the rotor therein.

Preferably, the heat-emitting portion comprises a plurality of cooling ribs, and the heat-emitting portion comprises a depressed plane depressed from the upper surface of the bracket. In this case, the plurality of cooling ribs may be formed at the plane depressed from the upper surface of the bracket. With the adoption of the depressed plane, a distance between the heat-emitting portion and the powered device is reduced, so the heat-emitting portion and the powered device can be maintained to come into contact with each other. Of course, the depressed plane has the effect of increasing an overall heat emission area of the heat-emitting portion. Also, forming the cooling ribs at the depressed plane has the effect of preventing the height of the bracket from increasing due to the cooling ribs. Accordingly, the depressed plane can be formed only at a part of the heat-emitting portion that comes into contact with the powered device, rather than being formed throughout the upper surface of the bracket.

Meanwhile, to further increase heat-emission effect, a heat-emitting grease may be coated or applied between the powered device and the heat-emitting portion. For the sake of heat emission, heat conduction is more efficient than heat convection. Therefore, in addition to a contact portion of the powered device that comes into direct contact with the heat-emitting portion, the remaining portion of the powered device is also adapted to come into indirect contact with the heat-emitting portion through the heat-emitting grease. This has the effect of increasing the surface area of the powered device that comes into contact with the heat-emitting portion.

Preferably, the PCB is secured to the stator after being coupled to the bracket by a screwing process such that the PCB comes into contact with the heat-emitting portion. That is, the powered device of the PCB can come into contact with the heat-emitting portion with a high contact efficiency as the PCB is screwed to the bracket. Preferably, the PCB is electrically connected to the stator and simultaneously, secured to the stator by a terminal tap.

In accordance with another aspect of the present invention, there is provided a permanent magnet rotor type motor comprising: a stator having a stator coil wound on an insulator, the stator coil having a terminal secured to the insulator; a printed circuit board (PCB) secured to an upper portion of the stator and having a powered device mounted on the PCB; and a terminal tap provided between the PCB and the terminal, the terminal tap being configured to electrically connect the PCB to the terminal while securing the PCB relative to the stator.

Here, the PCB is first coupled to an upper bracket portion having a heat-emitting portion formed at an upper surface of the upper bracket portion. Thereafter, the upper bracket portion is coupled to a lower bracket portion and simultaneously, the terminal tap is inserted into and secured to the terminal.

The terminal tap may comprise a body portion having a first end inserted into a hole formed at the PCB and a second end inserted into the terminal of the stator coil.

Supporting portions are formed at left and right sides of the body portion of the terminal tap, the terminal tap being structured to reinforce the rigidity of the body portion while maintaining a distance between the PCB and the terminal, one of the supporting portions being bent forward and the other supporting portion being bent rearward.

Preferably, the second end of the terminal tap is gradually reduced in width along a longitudinal direction of the terminal tap, so as to be efficiently inserted into the terminal. The second end of the terminal tap may comprise two fork blades each having a rounded tip end, and a distal end of the stator coil is inserted into a groove between the fork blades when the terminal tap is inserted into the terminal.

In accordance with yet another aspect of the present invention, there is provided a method for manufacturing a permanent magnet rotor type motor comprising: securing a terminal tap to a printed circuit board (PCB) having a powered device mounted on the PCB; securing the PCB to a bracket having a heat-emitting portion such that the powered device comes into contact with the heat-emitting portion; and securing the terminal tap to a stator having a stator coil wound on the stator to electrically connect the PCB to the stator coil.

Said securing the PCB to the bracket may include the PCB being secured to the bracket by a screwing process.

Said securing the terminal tap to the stator may be accomplished simultaneously when the upper and lower bracket portions are coupled to each other.

The above described permanent magnet rotor type motor according to the present invention has the following effects.

Firstly, heat generated from the PCB, more particularly, heat generated from the powered device provided at the PCB, can be efficiently emitted without separate heat-emission means. Also, the permanent magnet rotor type motor of the present invention can be easily manufactured with a simplified method.

Secondly, as a result of strongly securing the PCB to the bracket while electrically connecting the PCB to the stator, the permanent magnet rotor type motor of the present invention can achieve an increased durability.

Thirdly, the permanent magnet rotor type motor of the present invention has the effects of guaranteeing easy wiring between the PCB and the stator coil while efficiently preventing wiring errors, and of achieving a high reliability in the electric connection between the PCB and the stator coil.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a stator included in a conventional permanent magnet rotor type motor;

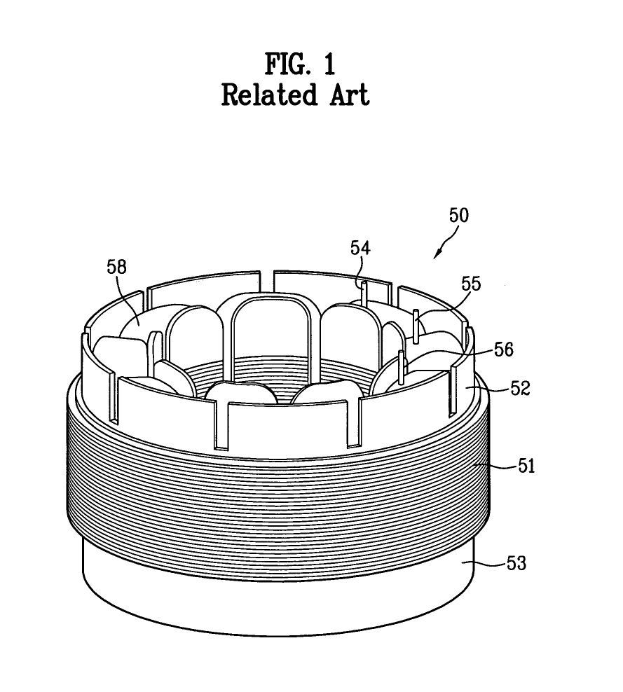

FIG. 2 is a perspective view illustrating a PCB secured to the stator of FIG. 1;

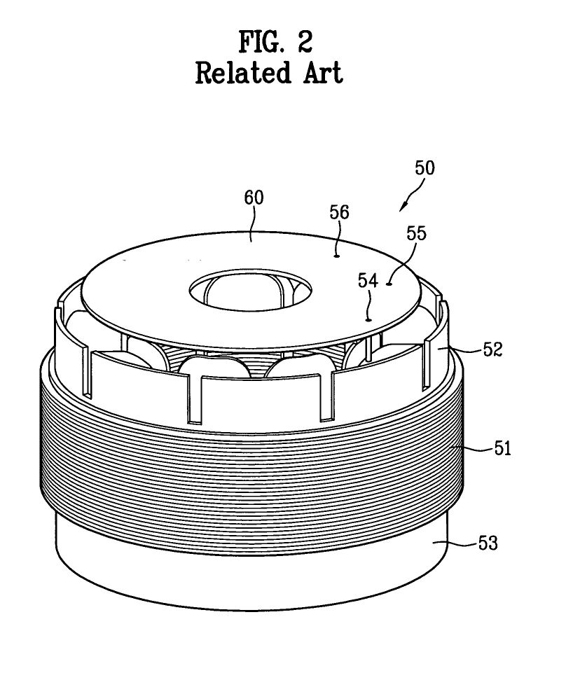

FIG. 3 is a circuit diagram illustrating a driving circuit of the permanent magnet rotor type motor;

FIG. 4 is a graph illustrating loss in a powered device;

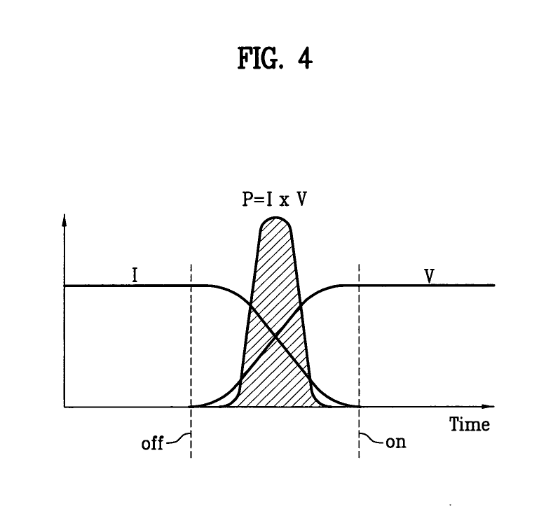

FIG. 5 is an exploded perspective view illustrating a permanent magnet rotor type motor according to the present invention;

FIG. 6 is a partial exploded perspective view illustrating a terminal tap and a PCB shown in FIG. 5; and

FIG. 7 is a partial sectional view illustrating the permanent magnet rotor type motor according to the present invention.

### DETAILED DESCRIPTION OF THE ILLUSTRATED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

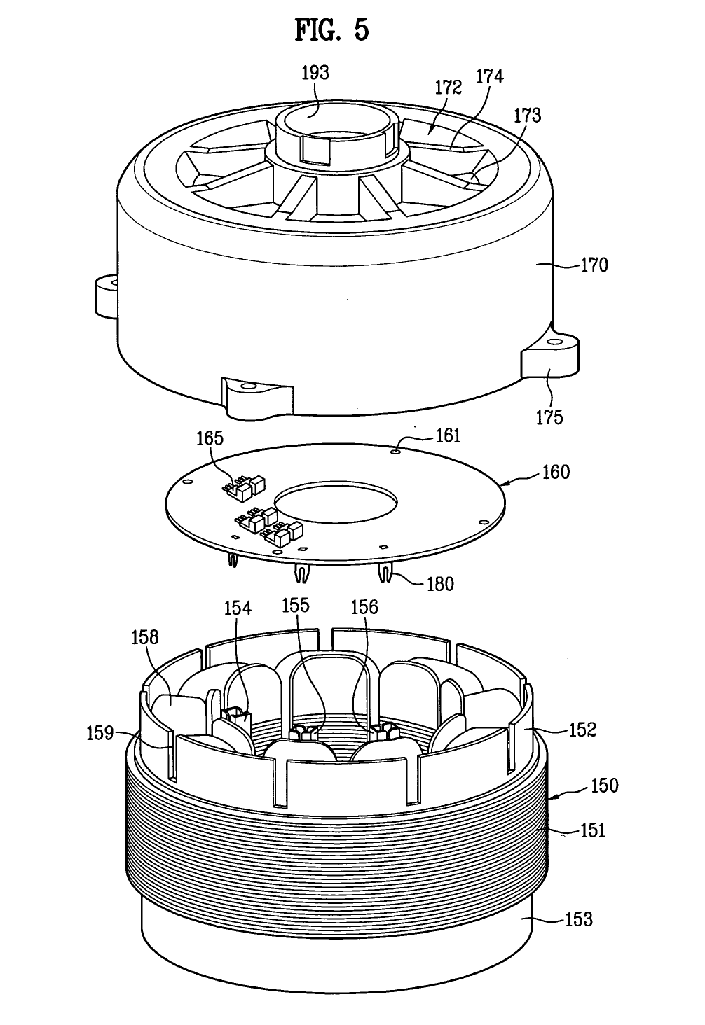

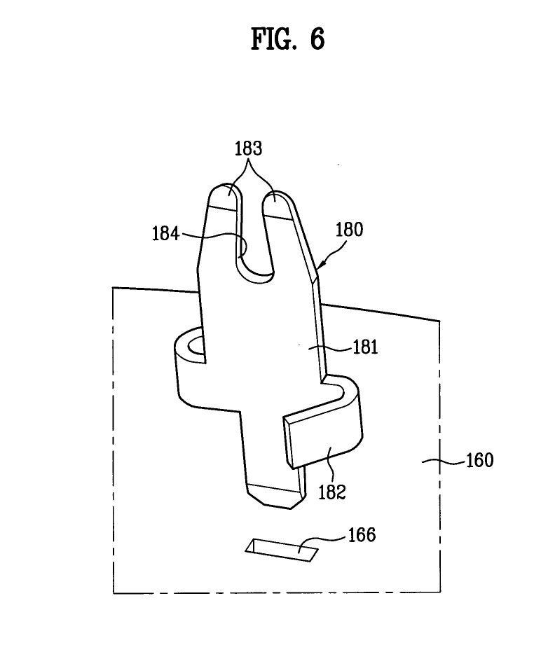

Now, a permanent magnet rotor type motor according to the present invention will be explained in detail with reference to FIGS. 5 to 7.

First, a bracket included in the permanent magnet rotor type motor according to the present invention will be described in detail.

The bracket is configured to receive a stator 150, a rotor (not shown), a PCB 160, and the like therein and defines the overall outer appearance of the motor. The bracket is integrally formed with a heat-emitting portion 172, so as to emit heat generated in the motor through the heat-emitting portion 172.

The bracket may be divided into an upper bracket portion 170 and a lower bracket portion 171. The upper and lower bracket portions 170 and 171 are coupled to each other, to define an internal space for receiving all internal constituent elements therein at fixed positions. The coupling of the upper and lower bracket portions 170 and 171 may be accomplished by fastening screws through coupling bosses 175 arranged along an outer surface of the bracket.

The heat-emitting portion 172 is formed at the upper bracket portion 170. Of course, although the heat-emitting portion 172 may be formed at the lower bracket portion 171, it is preferable that the heat-emitting portion 172 be formed at the upper bracket portion 170 when the PCB 160 is located in the upper bracket portion 170.

The heat-emitting portion 172 has a depressed plane 173 that is depressed by a predetermined depth from an upper surface of the upper bracket portion 170 and a plurality of cooling ribs 174 arranged on the depressed plane 173. To improve heat-emission performance of the heat-emitting portion 172, the depressed plane 173 and the cooling ribs 174 are designed to come into contact with outside air with an increased surface area. In particular, the depressed plane 173 serves to reduce a distance between the heat-emitting portion 172 and the PCB 160, so as to prevent an increase in the overall size of the motor due to the provision of the heat-emitting portion 172.

Here, the heat-emitting portion 172 may be formed throughout the upper surface of the upper bracket portion 170. However, in consideration of insulation between the PCB 160 and the upper bracket portion 170, it is preferable that the heat-emitting portion 172 be formed only at a specific portion including positions where powered devices 165 of the PCB 160 are located. This is to prevent heat, which was transferred from the powered devices 165 to the heat-emitting portion 172, from being transferred to other electric devices (not shown) mounted on the PCB 160.

The upper bracket portion 170 is formed, at an inner surface thereof, with coupling bosses 176 for the coupling of the PCB 160. Each of the coupling bosses 176 has a coupling hole 177 formed therein. Accordingly, as screws 178 are penetrated through the coupling holes 177 of the respective coupling bosses 176 to thereby be inserted into coupling holes 161 perforated in the PCB 160, the PCB 160 is secured to the inner surface of the upper bracket portion 170.

The above described bracket may be made of a variety of materials. For example, the bracket may be made of aluminum having a strong corrosion resistance and excellent formability. Accordingly, the bracket may be easily manufactured by die-casting aluminum. Since aluminum is a material having a high heat conductivity, the resulting bracket can show very excellent transmission of heat generated from the above described powered devices, thereby serving to efficiently emit heat through the heat-emitting portion 172.

Now, the PCB 160 included in the permanent magnet rotor type motor according to the present invention will be described in detail.

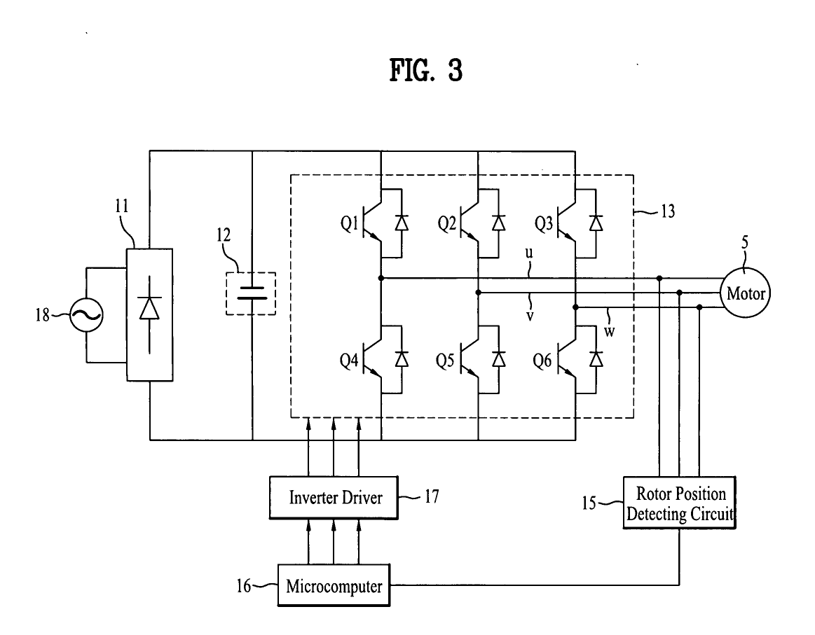

The PCB 160 is mounted with a variety of devices as shown in FIG. 3 as well as electric wiring patterns. In addition, the PCB 160 is formed with the coupling holes 161 for coupling the PCB 160 to the upper bracket portion 170. Preferably, a plurality of coupling holes 161 are formed at the PCB 160 along a circumferential direction of the PCB 160, to achieve further strong coupling and fixation of the PCB 160.

The PCB 160 is mounted with the powered devices 165 such that the powered devices 165 protrude upward from an upper surface of the PCB 160 by a predetermined height. The powered devices tend to generate a great amount of heat. Therefore, it is very important to efficiently emit the heat as described above.

The PCB 160 is also formed with holes 166 for the electric connection of stator coils 158 of different phases u, v, and w. In an embodiment, there may be provided three holes 166 corresponding to the respective phases u, v, and w. For the sake of electric connection, there are provided terminal taps 180 that will be described hereinafter. One end of each terminal tap is inserted into an associated one of the holes 166, to supply electric current to an associated one of the stator coils 158 of the phases u, v, and w. Of course, to achieve a further strong electric connection, the end of the terminal tap 180 may be subjected to a soldering process after being inserted into the hole 166.

Now, the terminal tap 180 included in the permanent magnet rotor motor according to the present invention will be described in detail.

The terminal tap 180 is used to electrically connect the PCB 160 to the associated stator coil 158. The terminal tap 180 has a shape suitable to facilitate the above described electric connection and is also used to secure the PCB 160 to an upper portion of the stator 150.

The terminal tap 180 has a body portion 181 and supporting portions 182. One end of the body portion 181 is connected to the PCB 160, and the other end of the body portion 181 is inserted into an associated one of terminals 154, 155, and 156 that will be described hereinafter, so as to be electrically connected to the associated stator coil 158.

Preferably, the end of the body portion 181 to be inserted into the hole 166 of the PCB 160 is chamfered or rounded for the sake of easy insertion of the end of the body portion 181.

Preferably, the other end of the body portion 181 to be coupled to the terminal is gradually reduced in width along a longitudinal direction of the body portion 181. This is to ensure easy insertion of the body portion 181 into the terminal. More particularly, by reducing the width of the other end of the body portion 181, even if the body portion 181 shows a slight positional deviation in the course of being coupled to the terminal, the positional deviation can be efficiently compensated, resulting in easy coupling between the body portion 181 and the terminal. Similarly, a pair of tip ends 183 formed at the other end of the body portion 181 are preferably chamfered or rounded.

The tip ends 183 may take the form of two fork blades. When the fork blades are inserted into the terminal 154, 155 or 156, a distal end of the stator coil 158, which is inserted into the terminal to thereby be secured to the terminal, is inserted into a groove 184 defined between the two fork blades, so as to be strongly secured to the groove 184. Accordingly, the groove 184 is preferably configured such that a width is gradually reduced toward an entrance of the groove 184.

In the present invention, it is preferable that the PCB 160 be first coupled to the upper bracket portion 170 and then, be coupled to the upper portion of the stator 150. This is because the PCB 160 must be secured such that the powered devices 165 of the PCB 160 come into contact with the heat-emitting portion 172 formed at the upper surface of the bracket 170. Accordingly, to allow the PCB 160 to be coupled to the upper portion of the stator 150, the stator 150 will be pushed into the upper bracket portion 170 with a strong manual force. In the course of manually pushing the stator 150 into the upper bracket portion 170, a relatively strong force may be applied to the terminal tap 180. Therefore, the terminal tap 180 must have a higher rigidity as compared to the case where the PCB 160 is first coupled to the upper portion of the stator 150. Of course, since the terminal tap 180 has to efficiently deal with the positional deviation of the terminal tap 180, the shape of the terminal tap 180 is a very important factor. Now, the shape of the terminal tap 180 will be described.

To obtain the desired rigidity, the terminal tap 180 of the present invention is configured such that the body portion 181 of the terminal tap 180 has a plate shape having a predetermined thickness. In addition, the supporting portions 182 are provided at left and right sides of the body portion 181, to further reinforce the rigidity of the body portion 181 and to maintain a distance between the PCB 160 and the associated terminal 154, 155, or 156. The supporting portions 182 are integrally formed with the body portion 181 such that one of the supporting portions 182 is bent forward and the other supporting portion 182 is bent rearward.

Hereinafter, the stator 150 included in the permanent magnet rotor type motor according to the present invention will be described in detail.

The stator 150 includes a stator core 151, upper and lower insulator portions 152 and 153 coupled to upper and lower portions of the stator core 151, and stator coils 158 wound on the upper and lower insulator portions 152 and 153. The insulators 152 and 153 are located between the stator core 151 and the stator coils 158 to insulate between the stator core 151 and the stator coils 158, in addition to securing the stator coils 158 wound on the insulators 152 and 153. Slots 159 are formed at the upper insulator portion 152 to be equidistantly arranged along a circumference of the upper insulator portion 152. The slots 159 are used to allow connecting wires (not shown) of the respective stator coils 158 to be fitted into the slots 159.

In FIG. 5, there are shown nine stator coils 158. For example, if the stator coils are prepared to form a total of nine-poles of three-phases, electric power has three phases u, v, and w. In this case, the stator coils of the three phases are spaced apart from one another by an angle of 120 degrees. Distal ends of the stator coils of each phase are inserted into the associated terminal 154, 155, or 156 formed at the upper insulator portion 152, to thereby be secured to the terminal. Preferably, the terminals 154, 155, and 156 are integrally formed with the upper insulator portion 152.

In the present invention, the distal ends of the stator coils 158 are electrically connected and secured to the PCB 160 through the terminals and the terminal taps 180, rather than being directly soldered to the PCB 160. This has the effect of not only facilitating the electric wiring of the stator coils 158, but also preventing wiring errors. When the distal ends of the stator coils are directly soldered to the PCB, there is a risk in that the stator coils of the different phases may be soldered to incorrect positions of the PCB due to the operator's mistake. However, in the present invention, since the stator coils are sequentially arranged and the terminals, to which the distal ends of the respective stator coils will be secured, are sequentially arranged, it is possible to efficiently prevent wiring errors.

Not described reference numeral “193” denotes a bearing fixture formed at the upper bracket portion 170 to receive an upper bearing therein. Although not shown, the lower bracket portion 171 is also provided with a lower bearing. With the use of the upper and lower bearings, a rotor (not shown) and a rotating shaft 190 can be rotatably supported to rotate together.

Hereinafter, a method for manufacturing the permanent magnet rotor type motor according to the present invention will be described in detail.

First, the terminal taps 180 are secured to the PCB 160 that is mounted with the powered devices 165. Then, to achieve a further reliable electric connection, the terminal taps 180 may be soldered to the PCB 160. The coupling relationship between the PCB 160 and the terminal taps 180 is clearly shown in FIG. 5.

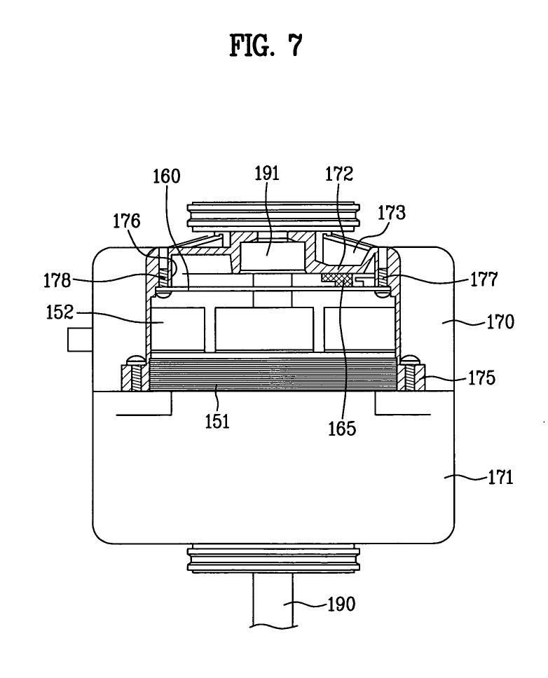

Subsequently, as shown in FIG. 7, the PCB 160 is secured to the bracket such that the powered devices 165 mounted on the PCB 160 come into contact with the heat-emitting portion 172 of the upper bracket portion 170. The coupling between the PCB 160 and the bracket may be accomplished by a screwing process. By screwing the PCB 160 to the bracket, an accurate and reliable electrical contact between the heat-emitting portion 172 and the powered devices 165 can be accomplished and maintained even if the motor is subjected to vibrations, etc.

It is noted that the maintenance of the above described electric contact is very important because a heat conduction manner can achieve more efficient heat transfer efficiency than a heat convection manner. Accordingly, heat generated from the powered devices 165 can be efficiently transmitted to the heat-emitting portion 172 via heat conduction, to thereby be emitted from the heat-emitting portion 172.

Of course, differently from the above description, after securing the PCB 160 to the bracket, the terminal taps 180 may be secured to the PCB 160. However, in this case, it is difficult to perform the soldering of the terminal taps 180 at a front side of the PCB 160.

Once the PCB 160 is coupled to the upper bracket portion 170 with the above described procedure, the stator 150 is secured to the PCB 160. Specifically, the terminal taps are secured to the terminals provided at the stator, so as to be electrically connected to the stator coils.

In this case, the coupling between the stator 150 and the PCB 160 may be accomplished simultaneously when the upper bracket portion 170 and the lower bracket portions 171 are coupled to each other. Specifically, first, the stator 150 is located in the lower bracket portion 171 at an appropriately selected position. Then, as the upper and lower bracket portions 170 and 171 are aligned and coupled to each other, the terminal taps 180 are inserted into the terminals 154, 155, and 156, whereby the PCB and the stator can be coupled to each other.

Here, as a result of providing the terminal taps 180 with the above described shape and sufficient rigidity, more easy manufacture of the permanent magnet rotor type motor is possible.

Preferably, a heat-emitting grease (not shown) is coated or applied between the powered devices 165 and the heat-emitting portion 172, to achieve an increase in heat-emission effect. The coating/application of the heat-emitting grease has the effect of enabling even a part of the powered devices, which are positioned so as not to come into direct contact with the heat-emitting portion 172, to come into indirect contact with the heat-emitting portion 172. This has the effect of increasing the heat conductive area of the powered devices by virtue of the heat-emitting grease, resulting in an improvement in heat-emission effect.

According to the present invention as described above, the PCB is coupled to the bracket such that the powered devices mounted on the PCB are coupled to the heat-emitting portion formed at the bracket, but the present invention is not essentially limited thereto. For example, the PCB may be coupled to the bracket such that other devices except for the powered devices, which are also mounted on the PCB and have a necessity for heat emission, come into contact with the heat-emitting portion of the bracket. Accordingly, all possible modifications related thereto belong to the technical idea of the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A permanent magnet rotor type motor comprising:
a stator having a stator coil wound about an insulator;
a Printed Circuit Board (PCB) secured to an upper portion of the stator and having a powered device mounted on the PCB; and
a bracket having a heat-emitting portion formed at an upper surface of the bracket, the bracket being configured to receive the stator and the PCB so that the powered device comes into contact with the heat-emitting portion.

2. The permanent magnet rotor type motor according to claim 1, wherein the bracket comprises an upper bracket portion formed with the heat-emitting portion and a lower bracket portion coupled to the upper bracket portion.

3. The permanent magnet rotor type motor according to claim 2, wherein the heat-emitting portion comprises a plurality of cooling ribs.

4. The permanent magnet rotor type motor according to claim 2, wherein the heat-emitting portion comprises a depressed plane that is depressed from the upper surface of the bracket.

5. The permanent magnet rotor type motor according to claim 4, wherein the depressed plane is formed at a part of the heat-emitting portion that comes into contact with the powered device.

6. The permanent magnet rotor type motor according to claim 5, wherein the depressed plane is formed with a plurality of cooling ribs.

7. The permanent magnet rotor type motor according to claim 1, wherein a heat-emitting grease is coated or applied between the powered device and the heat-emitting portion.

8. The permanent magnet rotor type motor according to claim 1, wherein the PCB is secured to the stator after being coupled to the bracket by a screwing process such that the PCB comes into contact with the heat-emitting portion.

9. The permanent magnet rotor type motor according to claim 8, wherein the PCB is electrically connected to the stator and simultaneously secured to the stator by a terminal tap.

10. A permanent magnet rotor type motor comprising:
a stator having a stator coil wound on an insulator, the stator coil having a terminal secured to the insulator;
a Printed Circuit Board (PCB) secured to an upper portion of the stator and having a powered device mounted on the PCB;
a terminal tap provided between the PCB and the terminal of the stator coil, the terminal tap being configured to electrically connect the PCB to the terminal while securing the PCB relative to the stator; and
a bracket having a heat-emitting portion formed at an upper surface of the bracket, the bracket being configured to receive the stator and the PCB so that the powered device comes into contact with the heat-emitting portion.

11. The permanent magnet rotor type motor according to claim 10, wherein the PCB is coupled to the bracket by a screwing process such that the PCB comes into contact with the heat-emitting portion after being coupled to the terminal tap.

12. The permanent magnet rotor type motor according to claim 10, wherein the terminal tap comprises a body portion having a first end inserted into a hole at the PCB and a second end inserted into the terminal of the stator coil.

13. The permanent magnet rotor type motor according to claim 12, wherein the terminal tap further comprises supporting portions formed at left and right sides of the body portion of the terminal tap, the terminal tap being structured to reinforce the rigidity of the body portion while maintaining a distance between the PCB and the terminal, one of the supporting portions being bent forward and the other supporting portion being bent rearward.

14. The permanent magnet rotor type motor according to claim 12, wherein the second end of the terminal tap is gradually reduced in width along a longitudinal direction of the terminal tap.

15. The permanent magnet rotor type motor according to claim 12, wherein the second end of the terminal tap comprises two fork blades each having a rounded tip end, and a distal end of the stator coil is inserted into a groove between the fork blades when the terminal tap is inserted into the terminal.

16. A method for manufacturing a permanent magnet rotor type motor comprising:
securing a terminal tap to a Printed Circuit Board (PCB) having a powered device mounted on the PCB;
securing the PCB to a bracket having a heat-emitting portion so that the powered device of the PCB comes into contact with the heat-emitting portion; and
securing the terminal tap to a stator having a stator coil wound on the stator to electrically connect the PCB to the stator coil.

17. The method according to claim 16, wherein said securing the PCB to the bracket includes the PCB being secured to the bracket by a screwing process.

18. The method according to claim 16, wherein the bracket comprises an upper bracket portion formed with the heat-emitting portion and a lower bracket portion coupled to the upper bracket portion to receive the stator and the PCB therein along with the upper bracket portion.

19. The method according to claim 18, wherein said securing the terminal tap to the stator is accomplished simultaneously with the coupling of the upper and lower bracket portions.

20. The method according to claim 16, wherein said securing the terminal tap to the PCB is performed after the PCB is secured to the bracket.
